(19) United States
(12) Patent Application Publication
(10) Pub. No.: US 2005/0032238 A1
(43) Pub. Date: Feb. 10, 2005

(54) Vented microfluidic separation devices and methods

(75) Inventors: Christoph D. Karp, Pasadena, CA (US); Ronald C. Gamble, Altadena, CA (US)

Correspondence Address: NANOSTREAM, INC., 580 SIERRA MADRE VILLA AVE., PASADENA, CA, 91107-2928, US

(73) Assignee: Nanostream, Inc., Pasadena, CA (US)

(21) Appl. No.: 10/927,570

(22) Filed: Aug. 25, 2004

Related U.S. Application Data
(63) Continuation-in-part of application No. 10/638,258, filed on Aug. 7, 2003.
(63) Continuation-in-part of application No. 10/880,656, filed on Jun. 29, 2004.

(51) Int. Cl. G01N 30/00

(52) U.S. Cl. 436/177; 422/100; 422/58

(57) ABSTRACT

A pressure-driven microfluidic device for separating chemical or biological species from a sample provides an on-board stationary phase packing manifold or distribution network for simultaneously packing multiple separation channels. The packing manifold or distribution may include both a stationary phase inlet port and a vent port, and the vent port may include an associated porous material or frit. Methods for operating pressure-driven microfluidic separation devices include the steps of venting the packing manifold to an environment having a lower pressure than that present in the separation columns to allow any retained sample portions to migrate away from the separation channels, thereby minimizing or eliminating cross-talk and sample contamination.

### STATEMENT OF RELATED APPLICATION(S)

This application claims benefit of commonly assigned U.S. patent applications, Ser. Nos. 10/638,258 and 10/880,656, filed Aug. 7, 2003 and Jun. 29, 2004, respectively.

### FIELD OF THE INVENTION

The present invention relates to the design and operation of multi-channel microfluidic devices and systems.

### BACKGROUND OF THE INVENTION

Chemical and biological separations are routinely performed in various industrial and academic settings to determine the presence and/or quantity of individual species in complex sample mixtures. There exist various techniques for performing such separations.

One particularly useful analytical process is chromatography, which encompasses a number of methods that are used for separating ions or molecules that are dissolved in or otherwise mixed into a solvent. Liquid chromatography (“LC”) is a physical method of separation wherein a liquid “mobile phase” (typically consisting of one or more solvents) carries a sample containing multiple constituents or species through a separation medium or “stationary phase.” Stationary phase material typically includes a liquid-permeable medium such as packed granules (particulate material) or a microporous matrix (e.g., porous monolith) disposed within a tube or similar boundary. The resulting structure including the packed material or matrix contained within the tube is commonly referred to as a “separation column.” In the interest of obtaining greater separation efficiency, so-called “high performance liquid chromatography” (“HPLC”) methods utilizing high operating pressures are commonly used.

In the operation of a conventional separation column, a sample is injected into a stream of mobile phase, such as by using a conventional loop valve. Means such as one or more pumps, voltage-driven electrokinetic flow, or gravitational force may be used to force mobile phase and sample(s) into and through a separation column. Sample constituents borne by mobile phase migrate according to interactions with the stationary phase, and the flow of these sample constituents are retarded to varying degrees. Individual sample components may reside for some time in the stationary phase (where their velocity is essentially zero) until conditions (e.g., a change in concentration of a mobile phase solvent) permit a component to emerge from the column with the mobile phase. In other words, as the sample travels through voids in the stationary phase, the sample may be separated into its constituent species due to the attraction of the species to the stationary phase. This attraction may be overcome due to, for example, a change in mobile phase composition. The time a particular constituent spends in the stationary phase relative to the fraction of time it spends in the mobile phase will determine its velocity through the column. Following separation in an LC column, the resulting eluate stream contains a series of regions each having an elevated concentration of different component species, which can be detected by various detection techniques (e.g., absorption, fluorescence, and/or mass spectrometry) to identify and/or quantify the species.

It is important to minimize any voids in a packed column, since voids or other irregularities in a separation system can destroy an otherwise good separation. As a result, most conventional separation columns include specially designed end fittings (typically having compressible ferrule regions) designed to hold packed stationary phase material in place and prevent irregular flow-through regions.

As illustrated in FIG. 1, a separation column for use in a conventional pressure-driven chromatography system is typically fabricated by packing particulate material 14 into a tubular column body 12. A conventional column body 12 has a high precision internal bore 13 and is manufactured typically with stainless steel, although materials such as glass, fused silica, and/or PEEK are also occasionally used. Various methods for packing a column body may be employed. In one example, a simple packing method involves dry-packing an empty tube by shaking particles downward with the aid of vibration from a sonicator bath or an engraving tool. A cut-back pipette tip may be used as a particulate reservoir at the top (second end), and the tube to be packed is plugged with parafilm or a tube cap at the bottom (first end). Following dry packing, the plug is removed and the tube 10 is then secured at the first end with a ferrule 16A, a fine porous stainless steel fritted filter disc (or “frit”) 18, a male end fitting 20A, and a female nut 22A that engages the end fitting 20A. Corresponding connectors (namely, a ferrule 16B, a male end fitting 20B, and a female nut 22B) except for the frit 18 are engaged to the second end to secure the dry-packed tube 12. The contents 14 of the tube 12 may be further compressed by flowing pressurized solvent through the packing material 14 from the second end toward the first (frit-containing) end. When compacting of the particle bed has ceased and the fluid pressure has stabilized, there typically remains some portion of the tube 13 that does not contain densely packed particulate material. To eliminate the presence of a void in the column 10, the tube 13 is typically cut down to the bed surface (or a shorter desired length) to ensure that the resulting length of the entire tube 12 contains packed particulate 14, and the unpacked tube section is discarded. Thereafter, the column 10 is reassembled (i.e., with the ferrule 16B, male end fitting 20B, and female nut 22B affixed to the second end) before use.

A conventional pressure-driven liquid chromatography system utilizing a column 10 is illustrated in FIG. 2. The system 30 includes a solvent reservoir 32, at least one (preferably two) high pressure pump(s) 34, a pulse damper 36, a sample injection valve 38, and a sample source 40 all located upstream of the column 10, and further includes a detector 42 and a waste reservoir 44 located downstream of the column 10. The high pressure pump(s) 34 pumps mobile phase solvent from the reservoir 32. A pulse damper 36 serves to reduce pressure pulses generated by the pump(s) 34. The sample injection valve 38 is typically a rotary valve having an internal sample loop for injecting a predetermined volume of sample from the sample source 40 into the solvent stream. Downstream of the sample injection valve 38, the column 10 contains stationary phase material that aids in separating species of the sample. Downstream of the column 10 is a detector 42 for detecting the separated species, and a waste reservoir 44 for ultimately collecting the mobile phase and sample products. A back pressure regulator (not shown) may be disposed between the column 10 and the detector 42.

The system 30 generally permits one sample to be separated at a time in the column 10. Due to its cost, a conventional column 10 is often re-used for several separations (e.g., typically about one hundred times or more). Following one separation, the column 10 may be flushed with a pressurized solvent stream in an attempt to remove any sample components still contained in the stationary phase material 14. However, this time-consuming flushing or cleaning step rarely yields a completely clean column 10. This means that, after the first separation performed on a particular column, every subsequent separation may potentially include false results due to contaminants left behind on the column from a previous run. Eventually, columns become fouled to the point that they are no longer useful, at which point they are generally discarded. A spent column 10 is removed from the system 30 by disengaging threaded fittings, and a new column 10 must be carefully connected via similar threaded fittings to prevent unintended leakage.

In an effort to reduce the number of parts required to fabricate separation columns, and to simplify their manufacture, microfluidic devices containing multiple HPLC columns have been developed, as described, for example, in commonly-assigned U.S. patent application Ser. No. 10/638,258, filed Aug. 7, 2003, the entirety of which is incorporated herein by this reference. These devices are used in high-throughput separation systems capable of separating multiple samples using a minimum number of expensive system components (e.g., pumps, pulse dampers, detectors, etc.), as described, for example, in commonly-assigned U.S. patent application Ser. No. 10/699,533, filed Oct. 30, 2003, the entirety of which is incorporated herein by this reference.

It has been found that multiple columns in such devices adapted to operate in parallel may be packed simultaneously from a common inlet via an integral stationary phase packing manifold or distribution network. Microfluidic devices with integral packing manifolds present substantial benefits over conventional single channel LC columns by reducing the complexity of the fabrication and operation.

In one packing method employing particulate-based stationary phase material, a slurry containing the stationary phase is supplied through a common inlet and a stationary phase manifold or distribution network to a group of channels each having an outlet that includes a liquid-permeable frit material. One advantage of utilizing a fluidic distribution network having a common inlet to distribute stationary phase material among a group of conduits (to fabricate separation columns) is that the apparatus is inherently self-correcting, since flow through the resulting network is naturally biased toward the path of least fluidic resistance. In other words, if a first channel (intended to become a first separation column) is more densely packed than a second channel (intended to become a second separation column) at any point in time during the slurry supply/packing process, then the second channel will exhibit a lower fluidic impedance—thus causing more particulate-containing slurry to be diverted to the second channel. Assuming that the remaining components with which the columns are fabricated (e.g., channel materials and dimensions, frits, etc.) are otherwise identical, the use of this self-correcting packing method yields a group of separation columns with inherently matched performance characteristics.

Preferably, stationary phase material is supplied to a multi-column device during a packing process until not only the columns but also the stationary phase manifold or distribution network is substantially filled with stationary phase material. Packing the stationary phase manifold or distribution network helps to prevent stationary phase material from becoming unpacked within the parallel columns.

One limitation associated with devices employing common stationary phase manifolds or distribution networks, however, is that the channel topology may permit certain conditions that may affect the separations performed with the device. For example, gas bubbles trapped in the packing manifold or network may compress as the system is pressurized, thus allowing portions of samples to be drawn into the packing manifold or network. When pressure is relieved, the bubbles may decompress and force retained sample portions back into the separation columns, potentially contaminating subsequent samples and the analyses thereof. In addition, portions of samples from one or more columns may migrate through the packing manifold/network and contaminate adjacent columns.

Thus, it would be desirable to provide systems and methods for performing parallel separations in microfluidic devices containing integral packing manifolds or distribution networks while minimizing cross-talk and residual contamination

### BRIEF DESCRIPTION OF THE DRAWINGS

FIG. 1 is a cross-sectional view of a conventional packed chromatography column.

FIG. 2 is a schematic showing various components of a conventional liquid chromatography system employing the packed chromatography column of FIG. 1.

FIG. 3 is top view of a portion of a first microfluidic separation device having two separation channels, two sample loading segments, and a stationary phase distribution manifold.

FIG. 4A is an exploded perspective view of a pressure-driven microfluidic separation device having eight separation channels, each separation channel having an associated sample input segment and a sample-loading segment.

FIG. 4B is a top view of the microfluidic device shown in FIG. 4A.

FIG. 5 is a top view of a multi-layer microfluidic device containing twenty-four separation columns suitable for performing pressure-driven liquid chromatography.

FIG. 6A is an exploded perspective view of a first portion, including the first through third layers, of the microfluidic device shown in FIG. 5.

FIG. 6B is an exploded perspective view of a second portion, including the fourth through sixth layers, of the microfluidic device shown in FIG. 5.

FIG. 6C is an exploded perspective view of a third portion, including the seventh through ninth layers, of the microfluidic device shown in FIG. 5.

FIG. 6D is an exploded perspective view of a fourth portion, including the tenth through twelfth layers, of the microfluidic device shown in FIG. 5.

FIG. 6E is a reduced scale composite exploded perspective view of the microfluidic device illustrated in FIGS. 5 and 6A-6D.

FIG. 7A is a flow chart showing the steps of a first method for performing high throughput pressure-driven liquid chromatography utilizing microfluidic devices such as illustrated in FIGS. 4, 4A-4B, 5 and 6A-6E.

FIG. 7B is a flow chart showing the steps of a second method for performing high throughput pressure-driven liquid chromatography utilizing microfluidic devices such as illustrated in FIGS. 4, 4A-4B, 5 and 6A-6E.

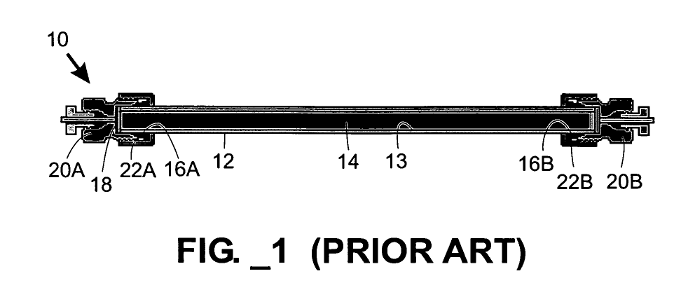

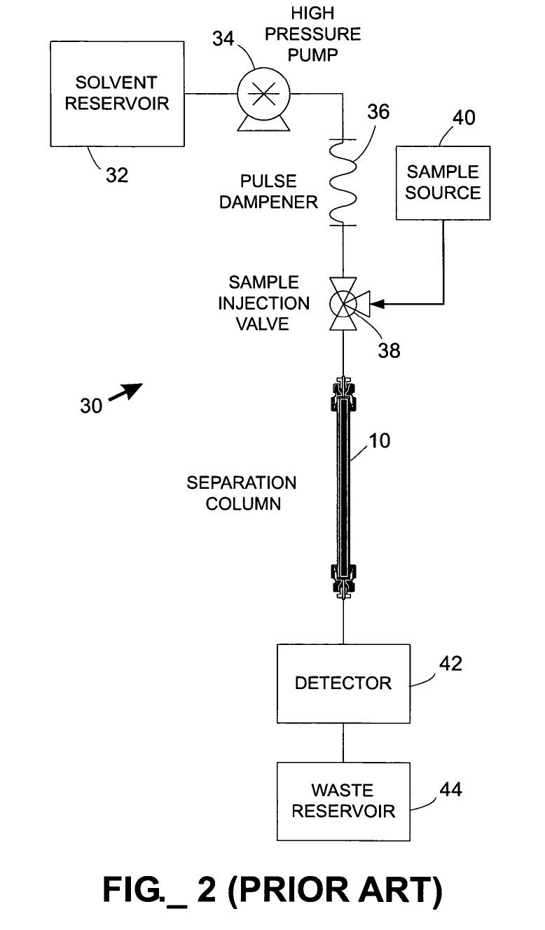

None of the figures are drawn to scale unless indicated otherwise. The size of one figure relative to another is not intended to be limiting, since certain figures and/or features may be expanded to promote clarity in the description.

### DETAILED DESCRIPTION OF PREFERRED EMBODIMENTS OF THE INVENTION

Definitions

The terms “column,” “separation column,” “channel,” or “separation channel” as used herein are used interchangeably and refer to a region of a fluidic device that contains stationary phase material and is adapted to perform a separation process.

The terms “fluidic distribution network” or simply “distribution network” refers to an interconnected, branched group of channels and/or conduits capable of adapted to divide a fluid stream into multiple substreams.

The term “frit” refers to a liquid-permeable material adapted to retain stationary phase material within a separation column.

The term “microfluidic” as used herein refers to structures or devices through which one or more fluids are capable of being passed or directed and having at least one dimension less than about 500 microns.

The term “parallel” as used herein refers to the ability to concomitantly or substantially concurrently process two or more separate fluid volumes, and does not necessarily refer to a specific channel or chamber structure or layout.

The term “plurality” as used herein refers to a quantity of two or more.

The term “stencil” as used herein refers to a material layer or sheet that is preferably substantially planar through which one or more variously shaped and oriented portions have been cut or otherwise removed through the entire thickness of the layer, and that permits substantial fluid movement within the layer (e.g., in the form of channels or chambers, as opposed to simple through-holes for transmitting fluid through one layer to another layer). The outlines of the cut or otherwise removed portions form the lateral boundaries of microstructures that are formed when a stencil is sandwiched between other layers such as substrates and/or other stencils.

The term “slurry” as used herein refers to a mixture of particulate matter and a solvent, preferably a suspension of particles in a solvent.

Microfluidic Devices Generally

Traditionally, microfluidic devices have been fabricated from rigid materials such as silicon or glass substrates using surface micromachining techniques to define open channels and then affixing a cover to a channel-defining substrate to enclose the channels. There now exist a number of well-established techniques for fabricating microfluidic devices, including machining, micromachining (for example, photolithographic wet or dry etching), micromolding, LIGA, soft lithography, embossing, stamping, surface deposition, and/or combinations thereof to define apertures, channels or chambers either in one or more surfaces of a material or penetrating through a material.

A preferred method for constructing microfluidic devices utilizes stencil fabrication, which involves the use of at least one stencil layer or sheet defining one or more microfluidic channels and/or other microstructures, with the at least one stencil layer disposed (preferably laminated) between outer or cover layers. One or both outer/cover layers preferably define at least one fluidic port to permit fluids to be supplied to or received from the device. As noted previously, a stencil layer is preferably substantially planar and has a channel or chamber cut through the entire thickness of the layer to permit substantial fluid movement within that layer.

Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filtration media. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Device layers may be directly bonded without using adhesives to provide high bond strength (which is especially desirable for high-pressure applications) and eliminate potential compatibility problems between such adhesives and solvents and/or samples. For example, in one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices. Additional bonding methods are disclosed in commonly assigned U.S. Patent Application Publication No. 2003/0106799, which is hereby incorporated by reference. In a preferred embodiment, an adhesiveless microfluidic device is adapted to withstand a fluidic supply pressure of at least about 100 pounds per square inch; more preferably at least about 250 pounds per square inch; and still more preferably at least about 500 pounds per square inch.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including ultrasonic, thermal, chemical, or light-activated bonding steps; mechanical attachment (such as using clamps or screws to apply pressure to the layers); combinations thereof; and/or other equivalent joining methods may be used.

Pressure-Driven Parallel Microfluidic Separation

Performing liquid chromatography in microfluidic volumes provides significant cost savings by reducing column packing materials, analytical and biological reagents, solvents, and waste. Microfluidic separation devices may also be made to be disposable, thus eliminating possible contamination of samples due to re-use of separation columns and eliminating the need to flush columns between separations. Embodiments fabricated with sandwiched stencil layers provide additional advantages, such as rapid and inexpensive prototyping and production, and the ability to use a wide range of materials portions of a device. Additionally, microfluidic devices are well-suited for performing multiple operations in parallel, thus permitting substantial increases in throughput (namely, the number of separations that can be performed within a particular period) to be obtained.

One method for fabricating microfluidic multi-channel separation devices developed by the assignee of the present application, as described in commonly-assigned U.S. patent application Ser. No. 10/366,985, filed Feb. 13, 2003 and Ser. No. 10/686,347, filed Oct. 14, 2003 (the entirety of which are incorporated herein by this reference), includes the steps of flowing slurry at high pressure through a slurry inlet port into a packing manifold or distribution network that distributes the flowing slurry from the slurry inlet port into each of the separation channels. Then particulate material from the slurry is retained within each channel by a frit or other porous region disposed at the downstream end of each separation channel.

A potential drawback of a packing manifold or distribution network in a device as just described, however, is that during operation the addition of pressurized fluid to the stationary phase material may cause a portion of the sample to migrate into the packing channel or manifold, potentially leading to contamination of subsequent samples in the same separation channel or in other separation channels in the system.

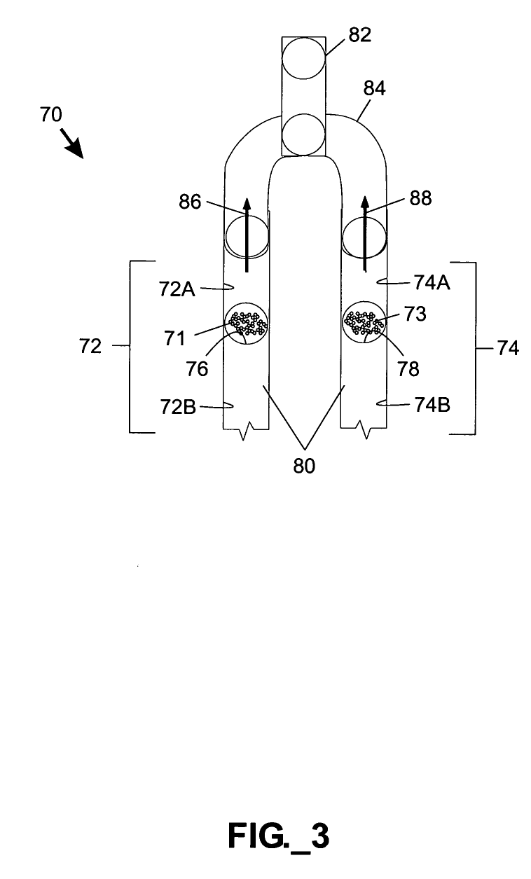

For example, referring to FIG. 3, a microfluidic device 70 includes separation channels 72, 74, each having a sample inlet port 76, 78. The sample inlet ports 76, 78 are disposed between an upstream portion 72A, 74A and a downstream portion 72B, 74B of the separation channels 72, 74, with both the upstream portions 72A, 74A and a downstream portions 72B, 74B containing a packed stationary phase material 80.

The stationary phase material 80 is packed in the separation channels 72, 74 using a slurry packing method (described above). Slurry is introduced to the device through common stationary phase inlet 82 and distributed to each separation channel 72, 74 through the packing manifold or network 84. Due to the method of chip fabrication, the upstream ends 72A, 74A of the separation channels 72, 74 lack a porous material or frit for retaining packed stationary phase material 80. Upon sealing the inlet 82 to impede fluid flow in the upstream direction in the upstream portions 72A, 74A of the separation channels 72, 74, it is believed that a small pocket of air becomes trapped within the upstream portions 72A, 74A and/or the packing manifold or network 84. When pressurized fluid is supplied to the separation channel 72, 74 through the sample inlets 71, 73, this pressure may be sufficient to push a portion of the sample 71, 73 in an upstream direction. Because the air pocket disposed at the upstream end is compressible, this permits some upstream migration of the samples 71, 73, as indicated by the arrows 86, 88.

When fluid pressure is released, any air bubbles tend to expand to an equilibrium state, thus pushing the portion of the samples 71, 73 contained in the upstream portion 72A, 74A in a downstream direction (i.e., in the direction of the sample inlets 76, 78). Any portion of the retained samples 71, 73 reaching the sample inlets 76, 78 may contaminate subsequent samples injected into the separation channels 72, 74, thus compromising analytical results obtained from the system.

Moreover, any portions of the retained samples 71, 73 that remain in the upstream portions 72A, 74A of the separation channels 72, 74 may migrate upstream (as denoted by arrows 86, 88) over subsequent separation procedures and eventually travel into the packing manifold or network 84. It has been observed that sample portions drawn into the packing manifold or network can migrate from one separation channel to another, resulting in cross-contamination between channels.

Improved Microfluidic Separation Devices and Methods

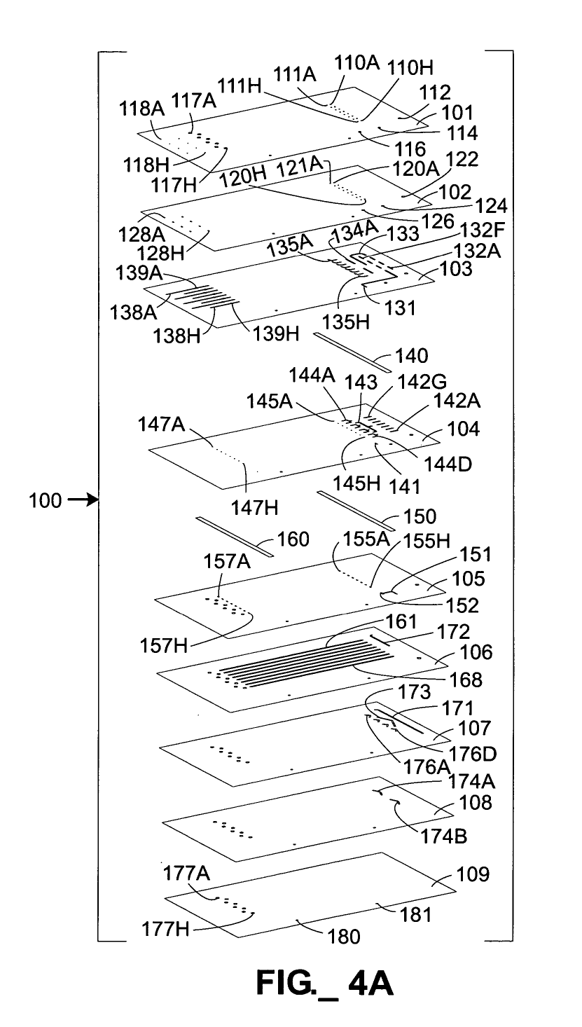

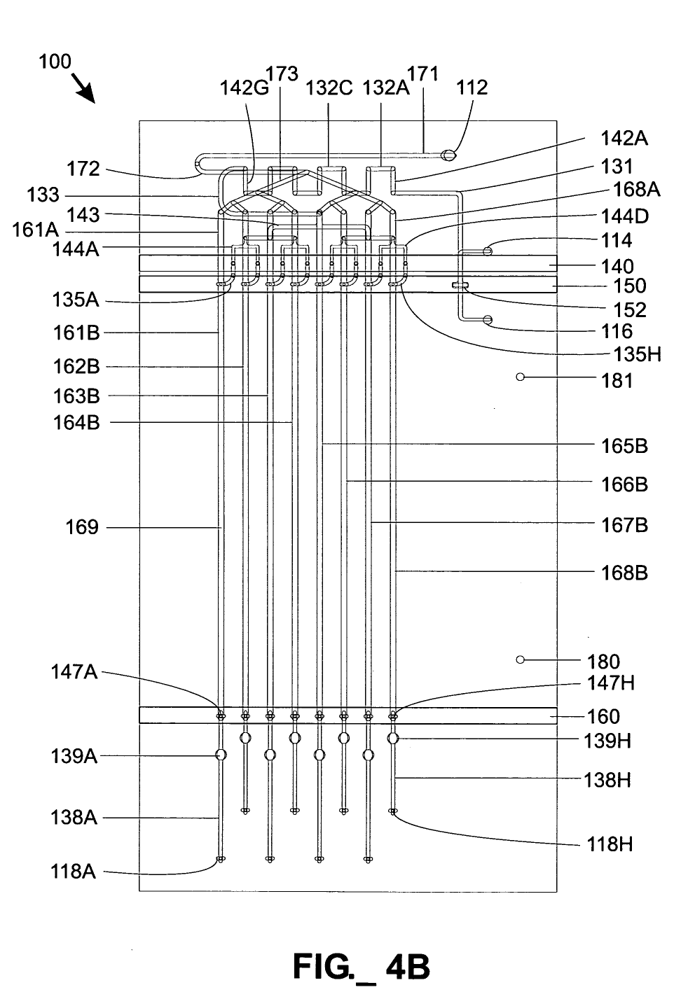

To avoid undesirable sample migration in a microfluidic separation device, embodiments of the present invention permit some pressurized mobile phase (solvent) to vent through the upstream portion of a separation channel. For example, FIGS. 4A-4B illustrate a pressure-driven microfluidic separation device 100 including eight separation channels 161-168. The device 100 may be constructed with nine device layers 101-109, including multiple stencil layers 103-108. Each of the nine layers 101-109 defines two alignment holes 180,181, which may be used in conjunction with fixed external pins (not shown) to aid in aligning the layers 101-109 during construction and/or to aid in aligning the device 100 with an external interface such as a mechanical seal (not shown) or slurry packing apparatus (not shown).

The first layer 101 defines several fluidic ports: three solvent inlet ports 112, 114, 116 that are used to admit mobile phase solvent to the device 100; eight pairs of sample ports 110A-110H and 111A-111H that permit samples to be supplied to sample loading segments 135A-135H (defined in the third layer 103); and eight outlet ports 118A-118H that permit mobile phase and separated sample species to exit the device 100 downstream of the separation channels 161-168. Due to the sheer number of elements depicted in FIGS. 4A-4B, numbers for selected elements within alphanumeric series groups (e.g., sample ports 110B-110G, 111B-111G, sample loading segments 135B-135G, outlet ports 118B-118G) are omitted for clarity. Notably, of the three solvent inlet ports 112, 114, 116, the first solvent inlet port 112 is additionally used to admit slurry to the device 100 during a column packing procedure. The first layer 101 further defines eight apertures 117A-117H that, along with identical apertures 177A-177H defined in the fifth through ninth device layers 105-109, facilitate optical detection by locally reducing the thickness of material bounding (from above and below) the detection regions 139A-139H of channels 138A-138H defined in the third layer 103.

The second through sixth layers 102-106 each define a first solvent via 122 for communicating a mobile phase solvent from a first mobile phase inlet port 112 to a transverse channel 171 defined in the seventh layer 107. A second solvent via 124 is defined in each of the second through fourth device layers 102-104 for communicating a mobile phase solvent from the second mobile phase inlet port 114 to a channel segment 151 defined in the fifth layer 105. A third solvent via 126 is defined in the second layer 102 to communicate a mobile phase solvent from the third mobile phase inlet port 116 to an initial solvent mixing channel 131 defined in the third layer 103. Eight pairs of sample vias 120A-120H and 121A-121H defined in the second layer 102 are interposed between the sample ports 110A-110H and 111A-111H and the sample loading segments 135A-135H defined in the third layer. Additionally, eight outlet vias 128A-128H are interposed between the outlet ports 118A-118H and the channels 138A-138H defined in the third layer 103.

In addition to the structures described previously, the third layer 103 defines a series of six transverse segments 132A-132F and a curved channel 133. The transverse segments 132A-132F and curved channel 133, when coupled with the longitudinal segments 142A-142G defined in the fourth layer 104, form continuous flow path between the initial solvent mixing channel 131 and the large forked channel 143 defined in the fourth layer 104. Further defined in the third layer 103 are two transverse segments 134A, 134B that fluidically couple the large forked channel 143 to four small forked channels 144A-144D defined in the fourth layer 104. In addition to the structures described previously, the fourth layer 104 defines eight sample loading vias 145A-145H and eight effluent vias 147A-147H. A first porous membrane 140 is disposed between the third and fourth layers 103,104, between the sample loading channels 135A-135H (defined in the third layer 103) and the small forked channels 144A-144D in the fourth layer 104. The purpose of this first porous membrane 140 is to impede the flow of samples (which are injected into the device 100 through sample input ports 110A-110H) into the small forked channels 144A-144H, thus preventing undesirable cross-talk or contamination between samples.

The fifth layer 105 defines a channel segment 151, eight junction vias 155A-155H disposed below the vias 145A-145H defined in the fourth layer 104, and eight effluent vias 157A-157H disposed at the downstream end of each separation channel 161-168. Two porous materials 150,160 are disposed between the fourth layer 104 and the fifth layer 105. These materials 150, 160 serve as frits to retain stationary phase material 169 within the separation channels 161-168 defined in the sixth layer 106. In other words, the frits 150, 160 permit the passage of liquid solvent, but impede the passage of stationary phase material 169. If the stationary phase material 169 includes packed particulate matter, then the frits 150, 160 preferably have a pore size that is smaller than each particle to be retained. Although various materials may be used for the frits 150, 160 (and the porous membrane 140), a preferred material for constructing these elements 140, 150, 160 is a permeable polypropylene membrane such as, for example, 1-mil (25 microns) thickness Celgard 2500 membrane (55% porosity, 0.209×0.054 micron pore size, Celgard Inc., Charlotte, N.C.). This is particularly preferred when the device layers 101-109 are fabricated with a substantially adhesiveless polyolefin material, such as non-biaxially-oriented polypropylene, using direct (e.g. thermal) bonding methods such as discussed herein. Devices 100 constructed according to such methods may be readily capable of withstanding (internal) operating pressures of 10 psi (69 kPa), 50 psi (345 kPa), 100 psi (690 kPa), 500 psi (3450 kPa), or even greater pressures.

The sixth layer 106 defines eight parallel separation channels 161-168 and a transverse channel segment 172. The seventh layer 107 defines an elongate transverse channel 171, one large forked channel 171, and four small forked channels 176A-176D. The eighth layer 108 defines two intermediate forked channels 174A-174B that permit fluid communication between the large forked channel 171 and the four small forked channels 176A-176D. The eighth layer 109, which serves to bound the forked channels 174A-174B from below, defines no channels; rather it defines only alignment holes 180-181 and apertures 177A-177H that facilitate optical detection.

Stationary phase material 169 is preferably added to the device 100 after the various layers 101-109 and porous elements 140, 150, 160 are laminated or otherwise bonded together to form an integral structure. While various types of stationary phase material may be used, preferred types include packed particulate material, and preferred packing methods employ slurry. One preferred slurry includes silica powder having surface chemical groups (e.g., Pinnacle II™ C-18 silica, 5-micron, catalog no. 551071, Restek Corp., Bellefonte, Pa.) and acetonitrile (MeCN), such as in a ratio of 1.00 grams particulate to 500 ml of solvent. Pressurized slurry may be supplied to the device 100 by way of a solvent inlet port 112. From the solvent inlet port 112 and associated vias 122, the slurry is split to the eight separation channels 161-168 through a microfluidic channel network that includes an elongate transverse channel segment 171, a reversing transverse channel segment 172, the large forked channel 173, the intermediate forked channels 174A-174B, and the small forked channels 176A-176D. Upon filling the separation channels 161-168, particulate matter within the slurry is prevented from leaving by way of the frits 150, 160, and solvent separated from the slurry emerges from the device 100 through the downstream frit 160, vias 147A-147H, channels 138A-138H, vias 128A-128H, and finally the outlet ports 118A-118H. Preferably, pressurized slurry is added to the device 100 until not only the separation channels 161-168 are filled, but also the forked channels 176A-176D, 174A-174D, 173 and the transverse segments 171-172 are filled so as to leave a trailing edge of stationary phase material disposed adjacent to the solvent inlet port 112.

In operation of the device 100, a first mobile phase solvent may be supplied to one solvent inlet port 114 and a second mobile phase solvent may be supplied to another solvent inlet port 116. These two solvents meet within the mixing channel 131 adjacent to the slit 141 (defined in the fourth layer 104), after which the two solvents are laminated one atop the other to promote mixing. Preferably, each solvent is supplied by an independently controlled pressure source (e.g., a pump) to permit gradient separation to be performed within the device 100. From the mixing channel 131, the combined solvents flow through a compact composite channel composed of seven longitudinal segments 142A-142G alternated with six transverse segments 132A-132F that provide a relatively long channel structure within a compact area. From the last longitudinal channel 142G, the solvent mixture flows into a curved channel 133 leading to a composite splitter including a large forked channel 143, a two intermediate channel segments 134A-134B, and four small forked channels 144A-144D that in turn supply the solvent mixture to the sample loading channels 135A-135H upstream of the sample loading ports 110A-110H. The sample loading channels 135A-135H are in fluid communication with the separation channels 161-168 at sample loading junctions 155A-155H disposed between the upstream portions 161A-168A and downstream portions 161B-168B of the separation channels 161-168. The junctions 155A-155H demarcate the transition from the upstream portions 161A-168A and the downstream portions 161B-168B.

After the stationary phase material 169 is fully wetted with solvent, samples may be added to the device 100 through the sample ports 110A-110H and 111A-111H. Preferably, solvent flow is interrupted and the device is temporarily depressurized (e.g., by disengaging a removable mechanical seal (not shown) from the sample loading ports 110A-110H, 111A-111H) to permit the samples to be loaded. Two sample ports (e.g., 110A, 111A) correspond to each sample loading segment (e.g., 135A) of the eight sample loading segments 135A-135H defined in the third layer 103. Preferably, different samples are provided to each upstream port (110A-110H) and each sample flows within a portion of a sample loading segment 135A-135H to emerge through the downstream port 111A-111H so as to define a sample plug of a repeatable volume in each sample loading segment between the upstream port (e.g., port 110A) and downstream port (e.g., 111A). After the samples are loaded, the sample loading ports 110A-110H, 111A-111H are preferably re-sealed (e.g., by disengaging a removable mechanical seal (not shown)) and solvent flow through solvent ports 112, 114, 116 is re-initiated. The solvents supplied into the sample loading segments 135A-135H from the sample inlet ports 114, 116 sweep the sample plugs onto the separation columns 161-168 where they flow into the through downstream portions 161B-168B and are eluted.

During operation, the solvent inlet port 112 is vented to an environment having a lower pressure than that in the separation channels 161-168. For example, the solvent inlet port 112 may be vented to atmosphere through a fluid conduit, such as a capillary line (not shown), leading to a waste collection chamber. Venting the solvent inlet port 112 allows any portion of a sample that has migrated into the upstream portions 161A-168A of the separation channels 161-168 to continue to migrate through the four small forked channels 176A-176D, two medium forked channels 174A-174B, and large forked channel 173 (which make up a slurry packing manifold). Because the sample portion can continue to migrate towards and eventually exit the device through the solvent inlet port 112, it is not drawn into the downstream portions 161B-168B of the separation channels 161-168 (either in the separation channel 161-168 from which it originated or adjacent channels 161-168) in subsequent separation operations.

One limitation associated with venting the slurry packing manifold or distribution network to a lower pressure environment, however, is that the flow of fluids from the upstream portions 161A-161B of the separation channels 161-168 through the slurry packing manifold or network and out of the device 100 through the solvent inlet 112 may act to unpack the stationary phase material 169. Any substantial unpacking of the stationary phase material 169 may be undesirable as it may result in voids or packing density variations in the separation channels 161-168, causing band spreading or other deleterious effects on the chromatographic separation of the sample.

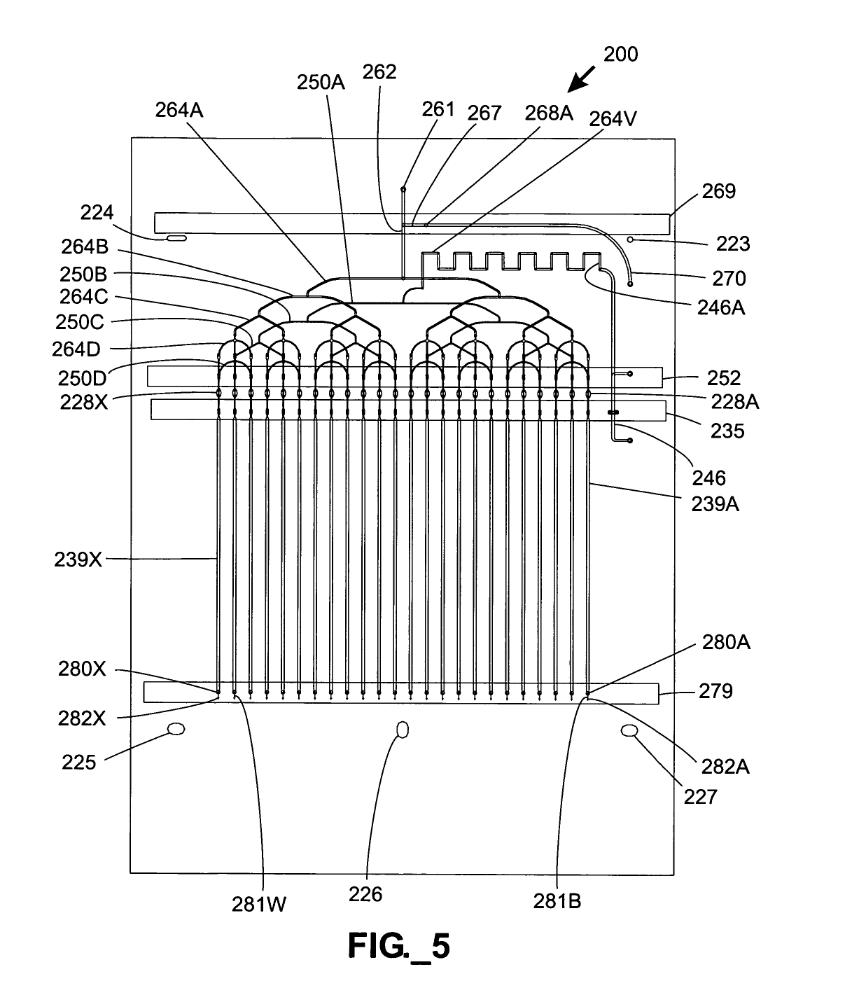

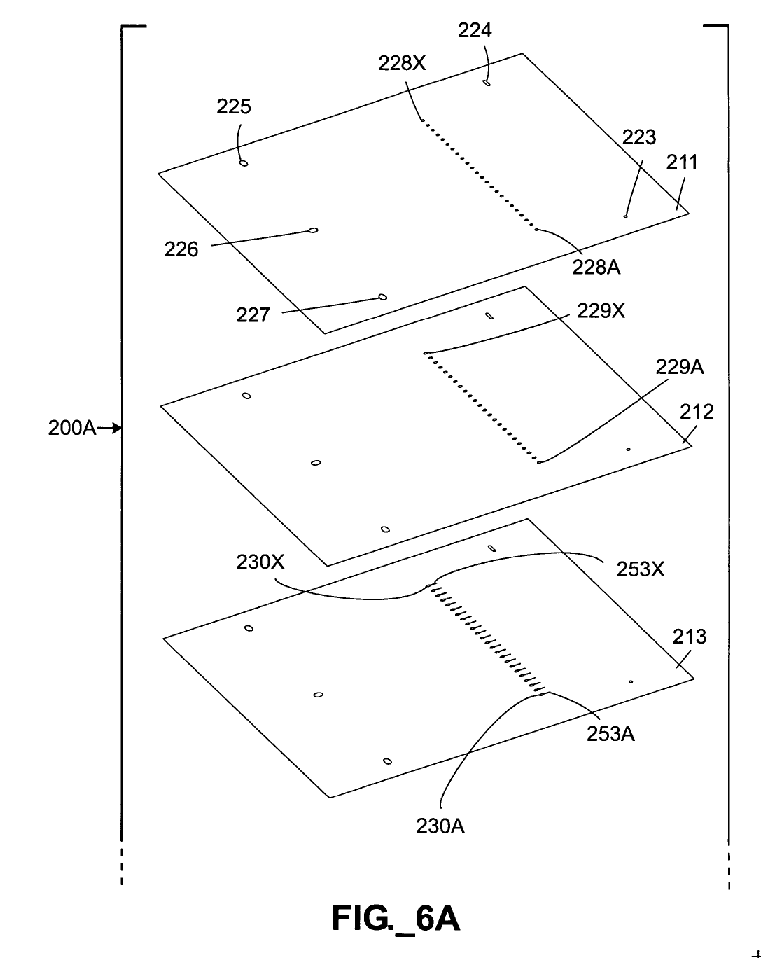

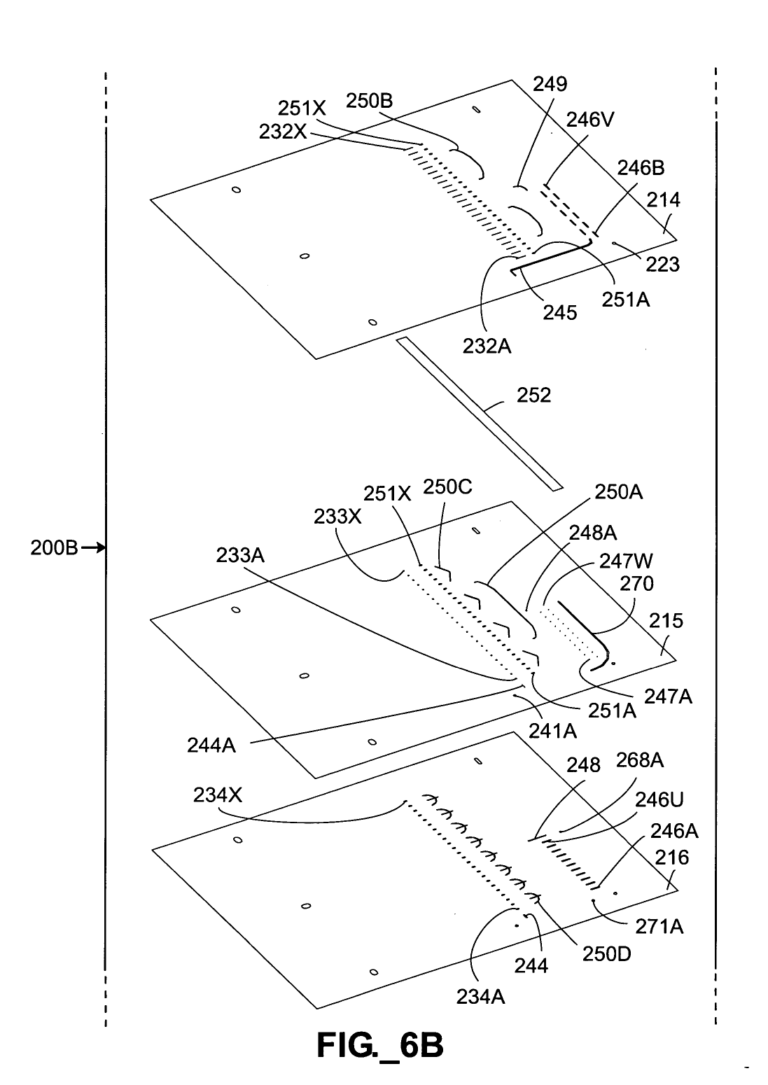

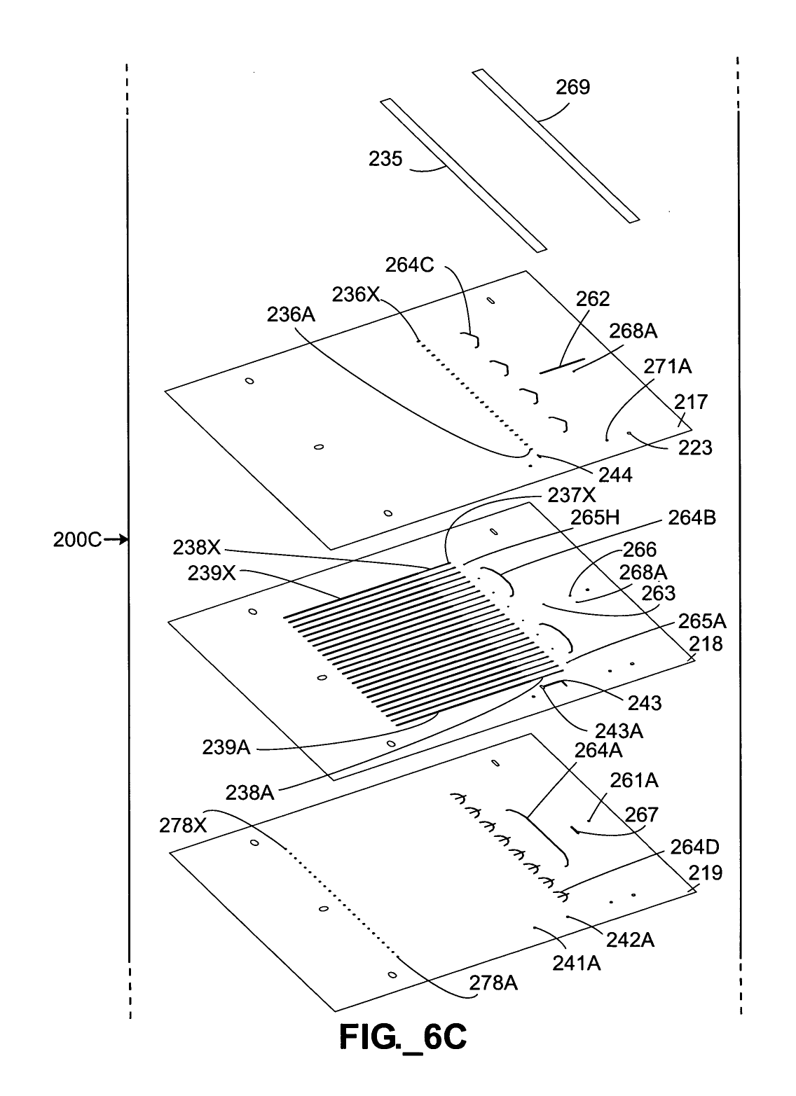

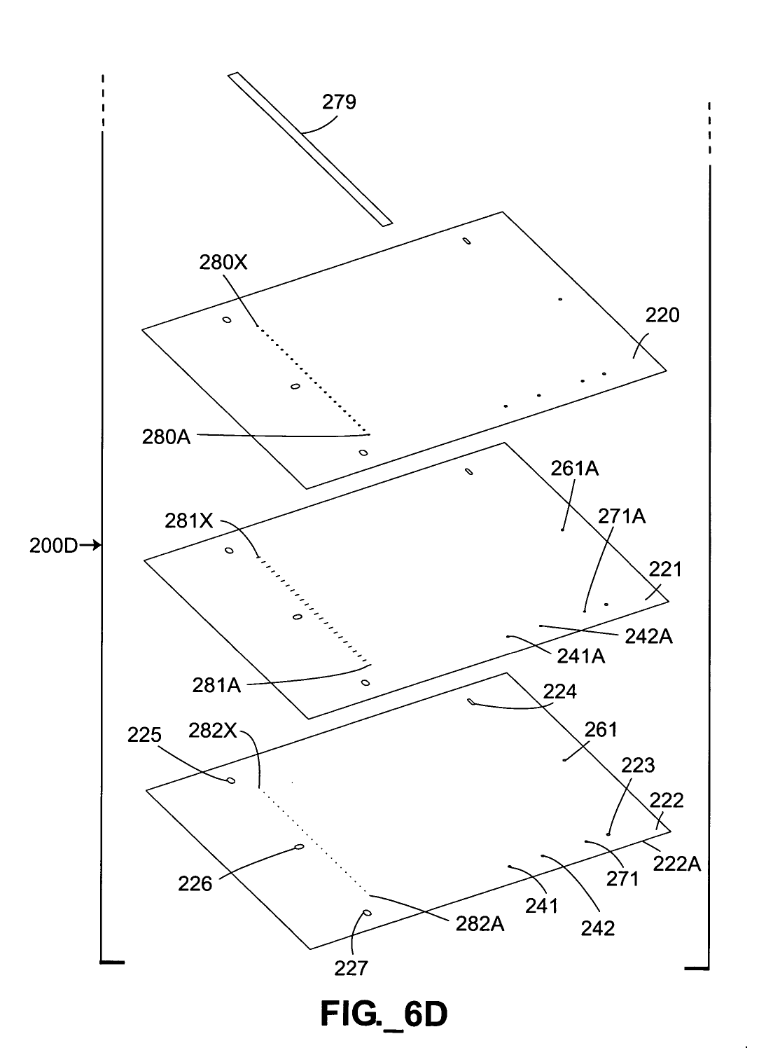

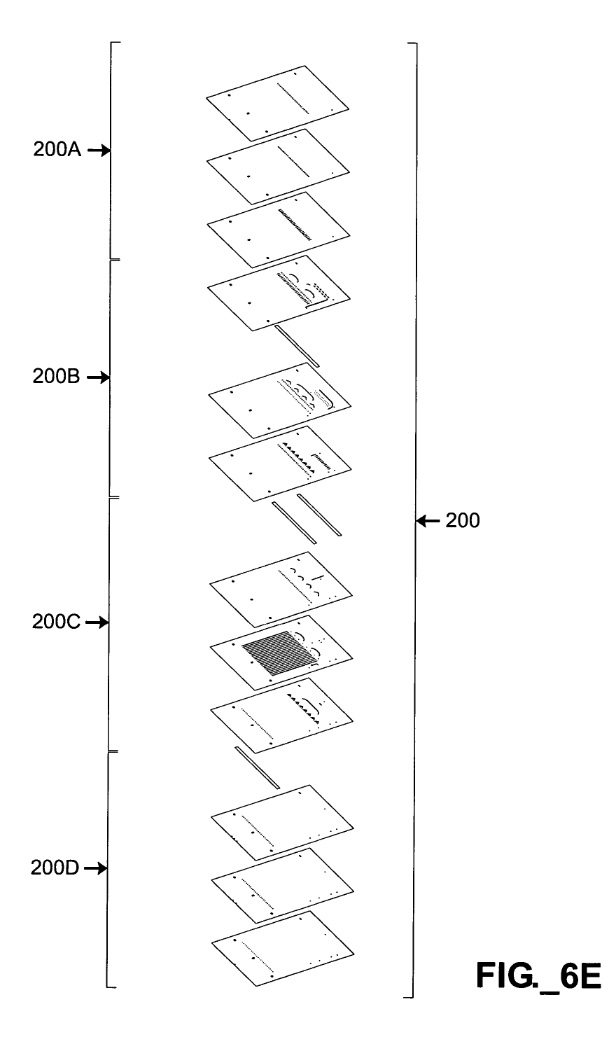

In another preferred embodiment, a device 200, illustrated in FIGS. 5 and 6A-6E may include a fritted venting channel 270 to further prevent the unpacking of stationary phase material. The device 200 includes twenty-four parallel separation channels (or “columns”) 239A-239X containing stationary phase material. The device 200 is constructed with twelve device layers 211-222, including multiple stencil layers 213-219, 221 and two outer or cover layers 211, 222. Each of the twelve device layers 211-222 defines five alignment holes 223-227, which may be used in conjunction with external pins (not shown) or equivalent structures to aid in aligning the layers during fabrication or may be used with an external interface (not shown) to position the device 200 for performing a packing process or for operating the device 200.

Preferably, the device 200 is constructed with materials selected for their compatibility with chemicals typically utilized in performing high performance liquid chromatography, including, water, methanol, ethanol, isopropanol, acetonitrile, ethyl acetate, dimethyl sulfoxide, and mixtures thereof. Specifically, the materials of the device should be substantially non-absorptive of, and substantially non-degrading when placed into contact with, such chemicals. Suitable device materials include polyolefins—such as polypropylene, polyethylene, and copolymers thereof—which have the further benefit of being substantially optically transmissive so as to aid in performing quality control routines (including checking for fabrication defects) and in ascertaining operational information about the device or its contents. For example, each device layer 211-222 may be fabricated from 7.5 mil (188 micron) thickness cast unoriented polypropylene (Copol International Ltd., Nova Scotia, Canada).

The first device layer 211 defines twenty-four sample inlet ports 228A-228X, each being oval-shaped with nominal dimensions of 65×50 mils (1.7×1.3 mm). The second device layer 212 defines twenty-four corresponding sample vias 229A-229X, each also being oval-shaped with nominal dimensions of 80×50 mils (2.0×1.3 mm). The third device layer 213 defines twenty-four sample wells 230A-230X (each being oval in shape and having nominal dimensions of 100×50 mils (2.5×1.3 mm)) and each having an associated mobile phase loading channel segment 253A-253X. When the device 200 is assembled and each corresponding first layer port (e.g., 228A), second layer via (e.g., 229A) and third layer well (e.g., 230A) is aggregated, the combination serves as an injection pit for receiving a sample. Thus, the device 200 may receive up to twenty-four different samples simultaneously—namely, a different sample through each sample inlet port 228A-228X. An external seal plate (not shown) is preferably pressed against the device 200 after sample loading is complete to permit the samples to be forced through the separation columns 239A-239X.

The fourth through sixth device layers 214-216 define a mobile phase distribution network 250 (inclusive of multiple channel elements 250A-250D) adapted to split a supply of mobile phase solvent among the twenty-four channel loading segments 253A-253X and ultimately the separation columns 239A-239X. In a preferred embodiment, the various channels of the mobile phase distribution network have widths of about 10 mils (0.25 mm). Upstream of the mobile phase distribution network 250, the fourth through sixth layers 214-216 further define mobile phase channels 248, 249 and structures for mixing mobile phase solvents, including a long mixing channel 245, wide slits 244, 244A, alternating channel segments 246A-246V (defined in the fourth and sixth layers 214, 216) and vias 247A-247W (defined in the fifth layer 215). In a preferred embodiment, the mixing elements (including channel 245 and segments 246A-246V) each have a nominal dimension (e.g., width) of about 20 mils (0.51 mm). Each of the fourth and fifth layers 214, 215 also define twenty-four solvent vias 251A-251X adjacent to an intermediate frit 252, with the fourth layer 214 further defining twenty-four sample/solvent channel segments 232A-232X. Additionally, the fifth and sixth layers 215, 216 define twenty-four sample/solvent vias 233A-233X, 234A-234X, respectively, and the fifth layer 215 defines an additional mobile phase via 248A.

Preferably, the device is adapted to retain particulate-based stationary phase material such as, for example, silica-based particulate to which functional groups (e.g., hydrophobic C-18 or other carbon-based groups) have been added. One difficulty associated with conventional microfluidic devices has been retaining small particulate matter within specific areas during operation at elevated pressures. The present device 200 overcomes this difficulty by utilizing liquid-permeable porous frits (e.g., frits 235, 269, 279) each having an average pore size that is smaller than the average particle size of the particulate-based stationary phase material. For example, each frit 235, 269, 279 may comprise a strip of porous material such as 1-mil thickness Celgard 2500 polypropylene membrane (55% porosity, 0.209×0.054 micron pore size, Celgard Inc., Charlotte, N.C.) and inserted into the appropriate regions of the stacked device layers 211-222 before the layers 211-222 are laminated together. Notably, the additional frit 252 disposed adjacent to the mobile phase distribution network 250 does not serve to retain stationary phase material but may be fabricated from the same material as the other frits (i.e., the sample injection frit 235, vent frit 269, and column outlet frit 279).

Preferably, an adhesiveless bonding method such as one of the methods described previously herein is used to interpenetrably bond the device layers 211-222 (and frits 235, 252, 269, 279) together. Such methods are desirably used to promote high bond strength (e.g., to withstand operation at high internal pressures of preferably at least about 100 psi (690 kPa), more preferably at least about 500 psi (3450 kPa)) and to prevent undesirable interaction between any bonding agent and solvents and/or samples to be supplied to the device 200.

While the device 200 includes twenty-four sample inlet ports 228A-228X defined in the first (top) layer 211, additional fluidic connections to the device 200 are made through ports defined in the twelfth (bottom) layer 222, namely: multiple mobile phase inlet ports 241, 242, a slurry inlet port 261, and a vent (outlet) port 271. Vias corresponding to these bottom ports 241, 242, 261, 271 are defined in multiple device layers to communicate fluids to or from the interior of the device 200, such as: first mobile phase solvent vias 241A defined in each of the fifth through eleventh layers 215-221; second mobile phase solvent vias 242A defined in each of the ninth through eleventh layers 219-221; slurry inlet vias 261A defined in each of the eighth through eleventh layers 218-221; and vent ports 271A defined in each of the sixth through eleventh layers 216-221.

A convenient method for packing stationary phase material within the separation channels 239A-239X is to provide it in the form of a slurry (i.e., particulate material mixed with a solvent such as acetonitrile). Following assembling and bonding of the device layers 211-222, slurry is supplied to the device 200 by way of the slurry inlet port 261, slurry vias 261A, channel segment 262, and a slurry distribution network 264 (inclusive of channel structures 264A-264D defined in the seventh through ninth layers 217-219). During the slurry packing process, the device 200 is preferably retained within an external packing manifold or distribution network (not shown). In a preferred embodiment, the channel segment 262 has a width of about 30 mils (0.76 mm) and each portion of the slurry distribution network 264 has a width of about 10 mils (0.25 mm). The vent port 271 is preferably in fluid communication with a slurry feed channel 262 to provide a path for air bubbles or other compressible fluids to escape the device 200 upon pressurization.

In support of these functions, the seventh device layer 217 defines a slurry channel 262, a vent via 268A, four medium forked channels 264C, twenty-four sample/solvent vias 236A-236X, and a slit-shaped mobile phase via 244 (in fluid communication with a mobile phase feed channel 243 and widened terminus 243A defined in the eighth layer 218). The eighth device layer 218 defines two vent vias 266, 268A, a slurry via 263, two large forked channels 264B, eight slurry packing vias 265A-265H, and twenty-four separation columns 239A-239X (nominally about 30 mils (0.76 mm) wide with an effective length of about 8 cm in a preferred embodiment) each having an associated narrow upstream portion 238A-238X (nominally about 10 mils (0.25 mm) wide in a preferred embodiment) and wider upstream terminus 237A-237X. The ninth layer 219 defines a vent channel segment 267, a very large forked channel 264A, eight small forked channels 264D each having three outlets, and twenty-four eluate vias 278A-278X.

In the aggregate, the very large, large, medium, and small forked channels 264A-264D form a slurry distribution network that communicates slurry from a single inlet (e.g., slurry inlet port 261) to the twenty-four separation channels 239A-239X. As particulate-containing slurry is added to the separation channels 239A-239X in a packing process, the particulate stationary phase material is retained within the separation channels 239A-239X by one column outlet frit 279 and by one sample injection frit 235, while the liquid portion of the slurry exiting the device 200 through the column outlet ports 281A-281X and the vent port 271. Note that the vent frit 269 serves to further prevent particulate material from unpacking or escaping the device 200 through the vent channel 270 or associated vent port 271. After stationary phase material is packed into the columns 239A-239X, a sealant (preferably substantially inert such as UV-curable epoxy) may be added to the slurry inlet port 261 to prevent the columns 239A-239X from unpacking during operation of the device 200. The addition of sealant should be controlled to prevent blockage of the vent via 266 and related vent structures including the vent channel 270. Further details regarding column packing methods are provided in commonly assigned U.S. Patent Application Publication No. 2003/0150806 entitled “Separation Column Devices and Fabrication Methods,” which is hereby incorporated by reference.

As an alternative to using packed particulate material, porous monoliths may be used as the stationary phase material. Generally, porous monoliths may be fabricated by flowing a monomer solution into a channel or conduit, and then activating the monomer solution to initiate polymerization. Various formulations and various activation means may be used. The ratio of monomer to solvent in each formulation may be altered to control the degree of porosity of the resulting monolith. A photoinitiator may be added to a monomer solution to permit activation by means of a lamp or other radiation source. If a lamp or other radiation source is used as the initiator, then photomasks may be employed to localize the formation of monoliths to specific areas within a fluidic separation device, particularly if one or more regions of the device body are substantially optically transmissive. Alternatively, chemical initiation or other initiation means may be used. Numerous recipes for preparing monolithic columns suitable for performing chromatographic techniques are known in the art. In one embodiment a monolithic ion-exchange column may be fabricated with a monomer solution of about 2.5 ml of 50 millimolar neutral pH sodium phosphate, 0.18 grams of ammonium sulfate, 44 microliters of diallyl dimethlyammonium chloride, 0.26 grams of methacrylamide, and 0.35 grams of piperazine diacrylamide.

Each of the tenth and eleventh device layers 220-221 define several vias 241A, 242A, 261A, 271A in fluid communication with corresponding ports 241, 242, 261, 271 defined in the twelfth device layer 222. Downstream of the separation columns 239A-239X, the tenth layer 220 defines twenty-four column outlet vias 280A-280X that are in fluid communication with twenty-four narrow near-surface channel segments 281A-281X defined in the eleventh layer 221 and, in turn, twenty-four elongated eluate (outlet) ports 282A-282X defined in the twelfth layer 222 and disposed lengthwise substantially perpendicular to the direction of the adjacent narrow channel segments 281A-281X. Notably, the combination of each outlet via 280A-280X, narrow near-surface channel segment 281A-281X, and transversely disposed elongated outlet port 282A-282X corresponds to the via 32, narrow segment 34, and transverse port 36 provide a fault-tolerant near-surface channel structure with low dead volume that is particularly well-suited for use with threadless external seals operated at high contact pressures. In a preferred embodiment, each device layer 211-222 has a thickness of about 7.5 mils (190 microns), each narrow channel segment 281A-281X measures approximately 7 mils×85 mils (178 microns×2.2 mm), and each transverse port 282A-282X measures approximately 7 mils×25 mils (178 microns×640 microns). Dimensional tolerances of roughly 1 mil (25 microns) may be expected if the device layers are patterned by laser cutting.

Utilizing the dimensions of this preferred embodiment, each narrow channel segment 281A-281X is disposed at a depth of about 7.5 mils (190 microns) (equal to the thickness of the twelfth layer 222) relative to the outer (e.g., lower) surface 222A of the device 200; thus, at a channel width of about 7 mils (178 microns), the width of each narrow channel segment 281A-281X is well less than about two times its depth—in fact, the width of each narrow channel segment 281A-281X is closer to parity with its depth relative to the outer surface 222A. Ensuring that the width of each narrow channel segment 281A-281X is less than about two times, or more preferably, less than or about equal to, the depth of each such segment 281A-281X helps to promote reliable threadless interconnection between the device 200 and external sealing components because the likelihood of significant localized deformation or collapse of the near-surface channel segments is dramatically reduced. In other words, careful selection of the ratio of width of the channel segments 281A-281X to their depth relative to the adjacent outer surface 222A permits external sealing components to be pressed against the lower surface 222A of the device 200 at high contact pressures without concern that a portion of the lower layer 222 will deflect into any channel segment 281A-281X and either (1) open an undesirable fluid flow path or gap between the sealing component and the outer surface 222A or (2) substantially occlude the channel segment 281A-281X.

After the various layers of the device 200 have been laminated or otherwise joined together, and after stationary phase material has been supplied to the separation channels 239A-239X, the device 200 may be readied for operation by supplying one or more mobile phase solvents through the mobile phase inlet ports 241, 242 while the sample inlet ports 228A-228X are temporarily covered with an external seal (not shown). The mobile phase solvents may be optionally pre-mixed upstream of the device 200 using a conventional micromixer (not shown) and then supplied to the device though only a single mobile phase inlet port 241, 242 of the two available ports 241, 242. If it is desired to provide mixing utility with the device 200, then the multiple solvents may be conveyed through several vias 241A, 242A to the mixing elements. A first solvent stream is supplied to the end of the long mixing channel 245, while another other solvent stream is supplied to a short mixing segment 243 that overlaps the mixing channel 245 through slit-shaped vias 244, 244A defined in the fifth through seventh device layers 215-217. One solvent is layered atop the other across the entire width of the long mixing channel 246 to promote diffusive mixing as the fluids flow through the “overlap mixing” channel 245, which has a nominal width of about 20 mils (0.51 mm) in a preferred embodiment. To ensure that the solvent mixing is complete, however, the combined solvents also flow through a second mixer of a different type composed of alternating channel segments 246A-246V and vias 247A-247W. The net effect of forcing the solvents through these alternating segments 246A-246V and vias 247A-247W is to cause the combined solvent stream to contract and expand repeatedly, augmenting mixing between the constituents of the two solvent streams initially supplied to the device 200.

The mixed solvents are supplied through channel segments 248, 249 to the distribution network 250 inclusive of forked channels 250A-250D. Each of the eight smaller forked channels 250D is in fluid communication with three of twenty-four sample loading channel segments 253A-253X. Additionally, each sample loading channel segment 253A-253X is in fluid communication with a different sample loading port 228A-228X by way of sample vias 229A-229X. To prepare the device 400 for sample loading, solvent flow is temporarily interrupted, an external interface (not shown) previously covering the sample loading ports 228A-228X is opened, and samples are supplied through the sample ports 228A-228X and the sample loading vias 229A-229X into the sample wells 230A-230X. Following sample loading, the sample loading ports 228A-228X are again sealed (e.g., with an external interface) and solvent flow is re-initiated to carry the samples onto the separation columns 239A-239X defined in the eighth layer 218.

While the bulk of the sample and solvent that is supplied to each column 239A-239X travels downstream through the columns 239A-239X in the direction of the outlet ports 282A-282X, a small split portion of each sample and solvent travels upstream through the columns 239A-239X in the direction of the stationary phase distribution network 264 and the vent port 270. That is, the split portions of sample and solvent from each column that travel upstream are consolidated by way of the slurry distribution network 264 (also containing packed stationary phase material to provide a high impedance to fluid flow) into a single waste stream that may flow through the vent port 270 to exit the device 200. One benefit of providing the vent port 270 in fluid communication with the columns 239A-239X is to permit air bubbles introduced during atmospheric pressure injection to escape the device 200 without worry of unpacking the slurry network 264 due to the presence of the frit 269. Providing a bubble escape path prevents pockets of compressed air (bubbles) from expanding upon release of the sample loading seal (not shown), which could lead to undesirable cross-contamination of samples from one separation run to the next and/or alter solvent gradient conditions from one column to another. In other words, since the device 200 is designed for atmospheric on-column sample injection, if there existed no means for venting the stationary phase distribution network 264 upstream of the sample injection ports 228A-228X, then the stationary phase network 264 would provide a stagnant “pocket” capable of retaining air bubbles, samples, and/or mobile phase solvents, and the process of depressurizing this pocket after pressurization would cause its contents to expand or surge into the sample injection wells 230A-230X and/or migrate across columns 239A-239X. Providing the vent 270 eliminates these problems. During operation of the device 200, the vent 270 is exposed or vented to an environment having a pressure less than the pressure of the mobile phase within the device 200. For example, the vent 270 may be vented to atmosphere, a pressurized container, an un-pressurized container, or any other suitable environment, which, being at a lower pressure, allows a portion of the mobile phase to flow in the manner described above. In one embodiment, the low pressure environment may be at a pressure of at least about fifty pounds per square inch less than the pressure of the mobile phase within the device 200. In another embodiment, the low pressure environment may be at a pressure of at least about two hundred fifty pounds per square inch less than the pressure of the mobile phase within the device 200.

Either isocratic separation (in which the mobile phase composition remains constant) or, more preferably, gradient separation (in which the mobile phase composition changes with time) may be performed with the device 200. If multiple separation columns are provided in a single integrated device (such as the device 200) and the makeup of the mobile phase is subject to change over time, then at a common linear distance from the mobile phase inlet it is desirable for mobile phase to have a substantially identical composition from one column to the next. This is achieved with the device 200 due to two factors: (1) volume of the path of each (split) mobile phase solvent substream is substantially the same to each column; and (2) each flow path downstream of the fluidic (mobile phase and sample) inlets is characterized by substantially the same impedance. The first factor, substantially equal substream flow paths, is promoted by design of the mobile phase distribution network 250. The second factor, substantial equality of the impedance of each column, is promoted by both design of the fluidic device 200 (including the slurry distribution network 264) and the simultaneous batch processing of multiple substantially identical columns 239A-239X via the common slurry network 264 from a common inlet port 261. During the packing process, with the multiple columns 239A-239X being in fluid communication from a common inlet 261, slurry flow within the device 200 is biased toward any low impedance region. The more slurry that flows to a particular column 239A-239X region during the packing process, the more particulate is deposited to locally elevate the impedance, thus yielding a self-correcting method for producing substantially equal impedance from one column to another.

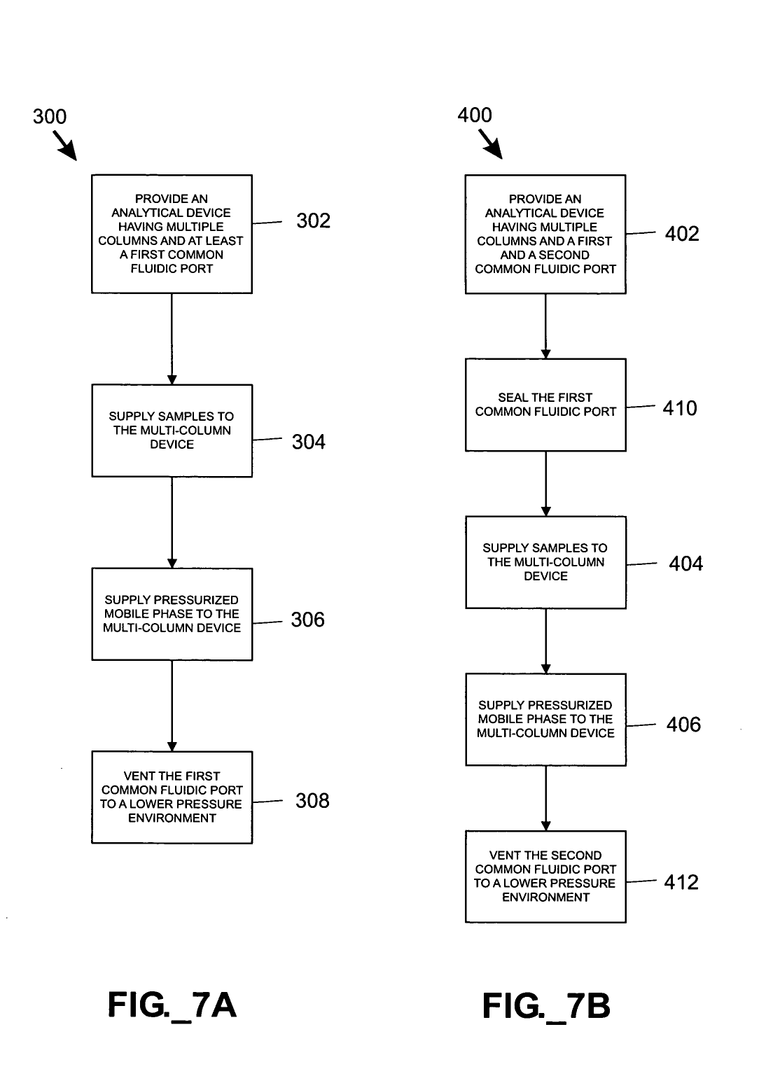

Referring to FIG. 7A, a first preferred method 300 for performing multiple separations in parallel includes multiple method steps. A first step 302 includes providing an analytical device having multiple parallel separation columns, each having an associated fluidic inlet port and an associated fluidic outlet port. The device also includes a stationary phase distribution network in fluid communication with the separation columns. The analytical device includes a first common fluidic port in fluid communication with the stationary phase distribution network. A second step 304 includes providing samples to the separation columns. A third step 306 includes supplying pressurized mobile phase to the separation columns. A first portion of the mobile phase flows through the fluidic outlet ports of the separation columns, and a second portion of the mobile phase flows into and/or through at least a portion of the stationary phase distribution network in the direction of the common fluidic port. A fourth step 308 includes venting the common fluid port to an environment having a lower pressure than the pressure in the separation columns.

Alternatively, as illustrated in FIG. 7B, a second preferred method 400 for performing multiple separations in parallel includes multiple method steps. A first step 402 includes providing an analytical device having multiple parallel separation columns. The device preferably includes a stationary phase distribution network in fluid communication with the separation columns. The analytical device includes a first common fluidic port in fluid communication with the stationary phase distribution network. The analytical device also includes a second common fluidic port in fluid communication with the stationary phase distribution network with a frit positioned in the flow path therebetween. A second method step 410 includes sealing the first common fluidic port. A third method step 404 includes supplying samples to the separation columns. A fourth method step 406 includes supplying pressurized mobile phase to the separation columns. A first portion of the mobile phase flows through the fluidic outlet ports of the separation columns, and a second portion of the mobile phase flows into (through) at least a portion of the stationary phase distribution network in the direction of the frit and the second common fluidic port. A fifth method step 412 includes venting the second common fluidic port to an environment having a lower pressure than the pressure in the separation columns. Additional steps may be added to the foregoing methods 300, 400.

While the embodiments illustrated herein represent a preferred fluidic device, one skilled in the art will recognize that devices according to a wide variety of other designs may be used whether to perform parallel liquid chromatography or other fluid phase separation processes (such as provided in commonly assigned U.S. application Ser. No. 10/821,567, entitled “Parallel Fluid Processing Systems and Methods,” filed Apr. 9, 2004, which is hereby incorporated by reference). Other functional structures, such as, but not limited to, sample preparation regions, fraction collectors, splitters, reaction chambers, catalysts, valves, mixers, and/or reservoirs may be provided to permit complex fluid handling and analytical procedures to be executed within a single device and/or system.

Although embodiments of the present invention have been described in detail by way of illustration and example to promote clarity and understanding, it will be apparent that certain changes and modifications may be practiced within the scope of the appended claims.

1. An analytical device comprising:
a plurality of parallel separation columns;
a stationary phase distribution network in fluid communication with the plurality of separation columns;
a first fluidic port in fluid communication with the distribution network;
a second fluidic port in fluid communication with the distribution network; and
a frit positioned between and in fluid communication with the second fluidic port and the distribution network.

2. The analytical device of claim 1 wherein the first fluidic port is substantially sealed.

3. The analytical device of claim 1, further comprising a plurality of device layers.

4. The analytical device of claim 3 wherein any device layer of the plurality of device layers comprises a substantially metal-free polymeric material.

5. The analytical device of claim 3 wherein any device layer of the plurality of device layers comprises a stencil layer.

6. The analytical device of claim 1 wherein any separation column of the plurality of separation columns is microfluidic.

7. The analytical device of claim 1 wherein the stationary phase distribution network is microfluidic.

8. The analytical device of claim 1, further comprising a stationary phase material contained within each separation column of the plurality of separation columns.

9. The analytical device of claim 7 wherein the stationary phase material comprises packed particulate material.

10. The analytical device of claim 7 wherein the stationary phase material comprises a microporous monolith.

11. A method for performing a plurality of separations in parallel, the method comprising the steps of:
providing an analytical device having:
a plurality of parallel separation columns;
a stationary phase distribution network in fluid communication with the plurality of separation columns; and
a first common fluidic port in fluid communication with the stationary phase distribution network;
supplying a plurality of samples to the plurality of separation columns;
supplying liquid mobile phase to the plurality of separation columns at a first pressure; and
venting the common fluidic port to an environment having a second pressure, wherein the second pressure is less than the first pressure.

12. The method of claim 11 wherein the second pressure is at least about fifty pounds per square inch less than the first pressure.

13. The method of claim 11 wherein the second pressure is at least about two hundred fifty pounds per square inch less than the first pressure.

14. The method of claim 11, further comprising the step of varying the first pressure over time.

15. The method of claim 11, further comprising the step of varying the composition of the liquid mobile phase over time.

16. The method of claim 11 wherein:
each separation column of the plurality of separation columns has first end, a second end, and an associated sample inlet port disposed between the first end and the second end; and
the sample supplying step includes providing a different sample of the plurality of samples to each separation column of the plurality of separation columns via its associated sample inlet port.

17. The method of claim 11 further comprising the steps of:
wetting the plurality of parallel separation columns; and
de-pressurizing the plurality of parallel separation columns prior to the sample supplying step.

18. The method of claim 11 wherein the analytical device comprises a microfluidic device.

19. A method for performing a plurality of separations in parallel, the method comprising the steps of:
providing an analytical device having:
a plurality of parallel separation columns, each separation column of the plurality of separation columns having an associated fluidic inlet port and an associated fluidic outlet port;
a stationary phase distribution network in fluid communication with the plurality of separation columns;
a first common fluidic port in fluid communication with the stationary phase distribution network;
a second common fluidic port in fluid communication with the stationary phase distribution network; and
a frit disposed between and in fluid communication with the second common fluidic port and the stationary phase distribution network;
sealing the first common fluidic port;
supplying a plurality of samples to the plurality of separation columns;
supplying liquid mobile phase to the plurality of separation columns at a first pressure; and
venting the second common fluidic port to an environment having a second pressure, wherein the second pressure is less than the first pressure.

20. The method of claim 19 wherein the second pressure is at least about fifty pounds per square inch less than the first pressure.

21. The method of claim 19 wherein the second pressure is at least about two hundred fifty pounds per square inch less than the first pressure.

22. The method of claim 19, further comprising the step of varying the first pressure over time.

23. The method of claim 19, further comprising the step of varying the composition of the liquid mobile phase over time.

24. The method of claim 19 wherein:
each separation column of the plurality of separation columns has first end, a second end, and an associated sample inlet port disposed between the first end and the second end; and
the sample supplying step includes providing a different sample of the plurality of samples to each separation column of the plurality of separation columns via its associated sample inlet port.

25. The method of claim 19 further comprising the steps of:
wetting the plurality of parallel separation columns; and
de-pressurizing the plurality of parallel separation columns prior to the sample supplying step.

26. The method of claim 19 wherein the analytical device comprises a microfluidic device.
